(19) United States
(12) Patent Application Publication
(10) Pub. No.: US 2012/0297603 A1
(43) Pub. Date: Nov. 29, 2012

(54) Hose Clamp Pliers

(76) Inventor: Barry J. Harrison, Davisburg, MI (US)

(21) Appl. No.: 13/479,892

(22) Filed: May 24, 2012

Related U.S. Application Data
(60) Provisional application No. 61/490,376, filed on May 26, 2011.

(51) Int. Cl. B25B 27/10; B23P 17/00; B23P 11/00

(52) U.S. Cl. 29/426.6; 81/9.3; 29/592

(57) ABSTRACT

A pliers for manipulating hose clamps or spring clamps can include channels for engaging the ears of a clamp. In summary, a pliers can include a first lever including a first jaw and a first handle, a second lever including a second jaw and a second handle, where the first jaw includes a first clamping surface including a plurality of channels and at least two channels in the first clamping surface are not parallel to one another, and where the second jaw includes a second clamping surface including a mirror-image plurality of channels that complement the channels on the first clamping surface.

### CLAIM OF PRIORITY

This application claims the benefit of prior U.S. Provisional Application No. 61/490,376 filed on May 26, 2011, which is incorporated by reference in its entirety.

### TECHNICAL FIELD

This invention relates to a hose clamp pliers and methods of using and making the apparatus.

### BACKGROUND

A hose clamp is a device used to attach and seal a hose onto a fitting such as a barb, tube or nib. A constant tension clamp, a type of hose clamp, can be formed using a strip of metal rolled to form a ring, with the ends forming protruding tabs or lugs. To use the spring clamp, the exposed tabs typically are pressed towards each other, increasing the diameter of the ring, and the constant tension clamp is slid onto the hose, past the portion that will go onto the barb or tube. The hose is then fit onto the barb, the constant tension clamp expanded again, and slid onto the portion of the hose over the barb or tube. The constant tension clamp is then released, compressing the hose onto the barb or tube.

### SUMMARY

In one aspect, a pliers can include a first lever, which can include a first jaw and a first handle, and a second lever, which can include a second jaw and a second handle. The first jaw can include a first clamping surface, which can include a plurality of channels and at least two channels in the first clamping surface may not parallel to one another. The second jaw can include a second clamping surface, which can include a mirror-image plurality of channels that can complement corresponding channels on the first clamping surface.

In another aspect, a method of using a pliers can include engaging a first lug of a hose clamp in a first channel of the plurality of channels in the first clamping surface, engaging a second lug of a hose clamp in a second channel of the plurality of channels in the second clamping surface, where the second channel can be the complementary channel of the first channel, and applying a force to the first handle and the second handle to release the hose clamp.

In another aspect, a method of making the pliers can include forming the plurality of channels in the first clamping surface, where at least two of the channels may not be parallel to one another, and forming the mirror-image plurality of channels in the second clamping surface that can complement corresponding channels on the first clamping surface.

In some embodiments, the first clamping surface can include a channel which can be parallel to the first lever. In some embodiments, the first clamping surface can include a channel which can be perpendicular to the first lever. In some embodiments, the first clamping surface can include a channel which can be at a preselected angle relative to the first handle. In some embodiments, the first clamping surface can include two or more of a channel which can be parallel to the first lever, a channel which can be perpendicular to the first lever, or a channel which can be at a preselected angle relative to the first handle.

In some embodiments, a channel can be at least 0.05 inch, at least 0.1 inch, at least 0.2 inch, at least 0.25 inch or at least 0.3 inch deep. The depth of the channel can be measured from the clamping surface, which can include a texture. Therefore, the depth of a channel can be measured from a plane including the highest points of the texture. A channel can be at least 0.05 inch, at least 0.1 inch, at least 0.15 inch, at least 0.2 inch or at least 0.25 inch wide.

In some embodiments, the first clamping surface can include an angled edge which can be parallel to the channel in the first clamping surface at a preselected angle relative to the handle of the pliers, and the second clamping surface can include an angled edge which can be a mirror-image of the angled edge in the first jaw.

In some embodiments, the first jaw can be wider than the first handle and the second jaw can be wider than the second handle. In some embodiments, a jaw can be at least, 0.25 inch wide, at least 0.5 inch wide, at least 0.625 inch wide, at least 0.75 inch wide, at least 0.875 inch wide or at least 1 inch wide. In some embodiments, a jaw can be at most 2.0 inches wide, at most 1.75 inches wide, at most 1.5 inches wide, at most 1.25 inches wide or at most 1.0 inch wide. In some embodiments, the width of the first jaw and the width of the second jaw, independently, can be at least 0.5 inch wide. In some embodiments, the width of the first jaw and the width of the second jaw, independently, can be at most 1.25 inch wide.

In some embodiments, the first jaw can be off-set from a lengthwise axis of the first handle, and the second jaw can be off-set from a lengthwise axis of the second handle.

In some embodiments, at least two channels in the first clamping surface can intersect at a point that can be off-set from a lengthwise axis that can be substantially at the center of the first clamping surface.

### BRIEF DESCRIPTION OF THE DRAWINGS

FIG. 1a shows a first lever of a pliers.

FIG. 1b shows a second lever of a pliers.

FIG. 2 shows a first lever of a pliers.

FIG. 2 shows a first lever of a pliers.

FIG. 4 shows a lever of a pliers.

FIG. 5a shows a pliers engaged with lugs of a hose clamp.

FIG. 5b shows a pliers engaged with lugs of a hose clamp.

FIG. 5c shows a pliers engaged with lugs of a hose clamp.

FIG. 6a shows a variety of hose clamps of different sizes.

FIG. 6b shows a perspective view of a hose clamp.

FIG. 6c shows a perspective view of a hose clamp.

FIG. 7 shows a perspective view of a slip joint.

### DETAILED DESCRIPTION

A hose clamp, also called a spring clamp or constant tension clamp, can be applied in a wide variety of locations using a proper tool. Applying a hose clamp can be difficult because they are often used in narrow spaces or in locations with restrictive angles. Additionally, the wide variety in the diameter of hose clamps can also make applying them difficult. For example, constant pressure hose clamps are used by original equipment manufacturer to speed up the fitting of parts during assembly of vehicles during production. These hose clamps can be problematic for a technician to release and refit them during a repair operation. Currently technicians use a normal pair of pliers to release/refit smaller sizes of constant pressure clamps, such as those used on heater hoses. Using a normal pair of pliers can challenging because the pliers are not designed for this purpose and the width of the head of the pliers is not wide enough to accommodate the lugs (also called ears or upstanding flanges) of the of the constant pressure clamps. Therefore, there is a need for a pair of pliers that can be used to release and refit a variety of hose clamps whose lugs are of varying widths. More specifically, there is a need for a pliers to provide the ability to release/refit the constant tension clamps at different attitudes and angles to permit access to the majority of constant tension clamps within the vehicle engine compartment.

Generally, a device can be a clamping device, for example, a pliers, a vice, or a tongs. A device can also be a clamping device as described in Patent Application PCT/US11/21406, which is incorporated by reference in its entirety.

A pliers can be used with clamps of a variety of diameters, which can be applied in locations at difficult angles. A pliers can use a large slip joint pliers as the basis for the new tool to provide an opening wide enough to open all sizes of clamps. A jaw or pair of jaws of the pliers can be widened to accommodate all sizes of clamps. A pliers can provide the ability to release and refit the majority of constant pressure clamps, for example, within a vehicle engine compartment.

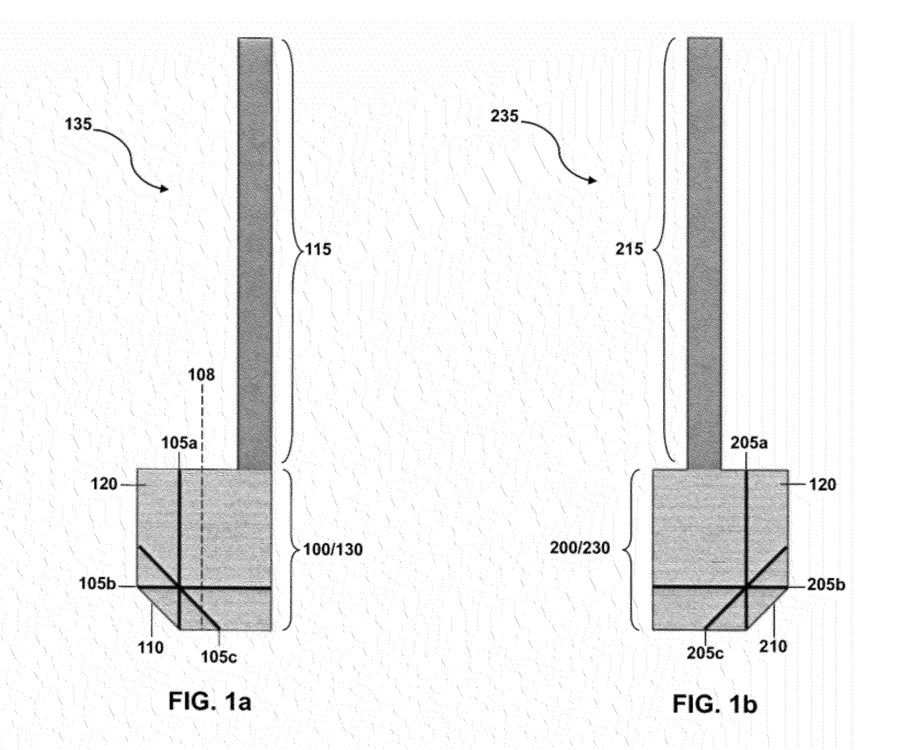

Referring to FIGS. 1a and 1b, a pliers can include a first lever 135 and a second lever 235. A first lever 135 can include a first jaw 130 and a first handle 115. A second lever 235 can include a second jaw 230 and a second handle 215.

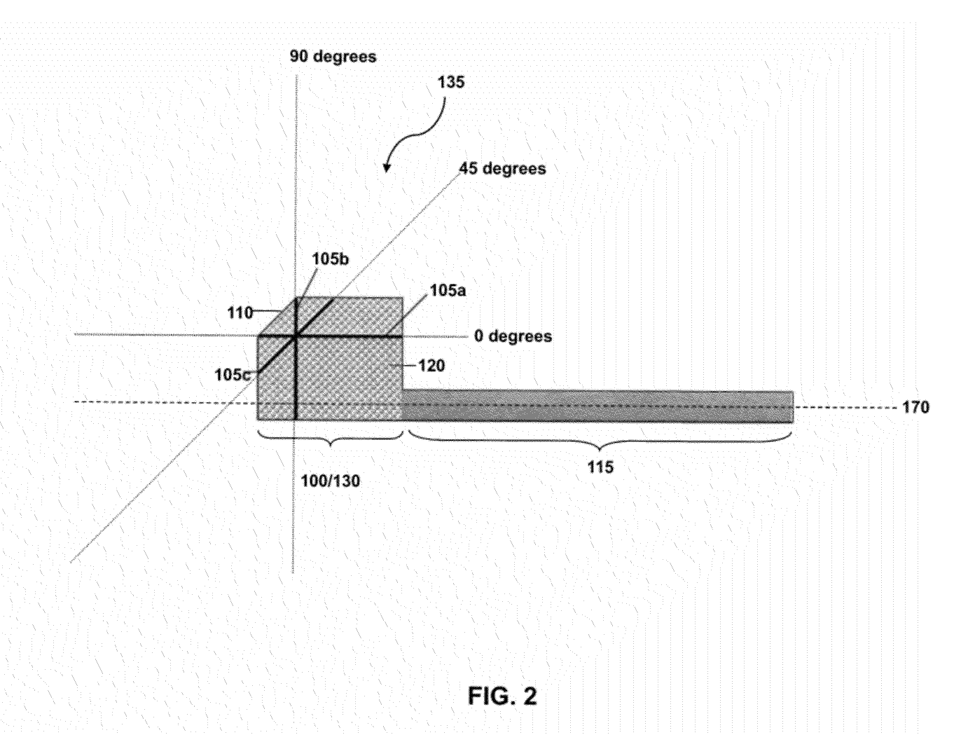

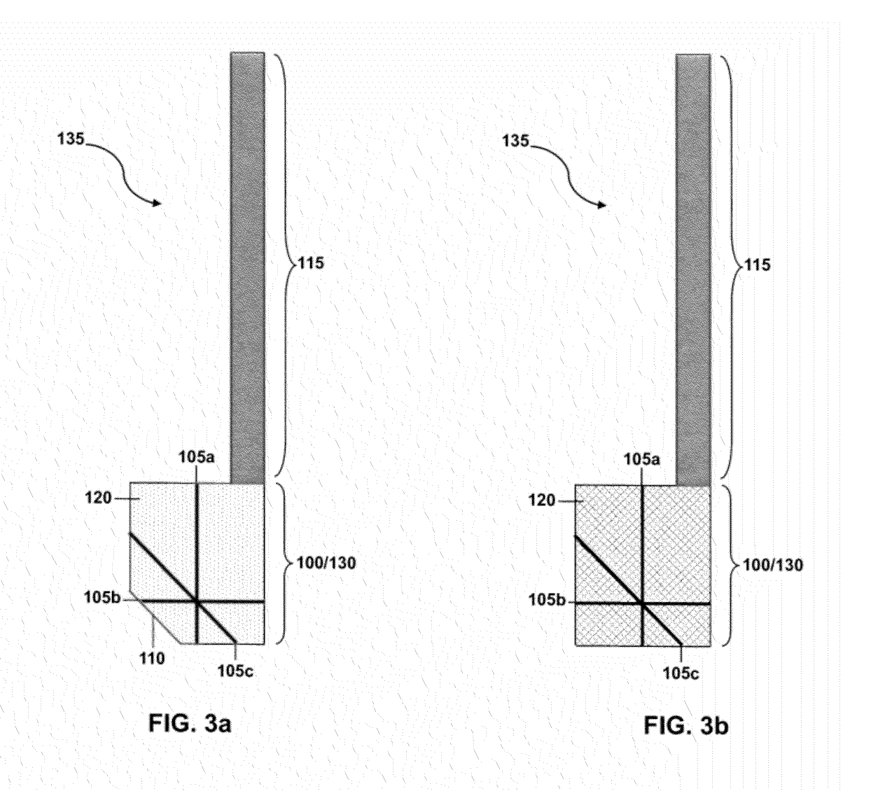

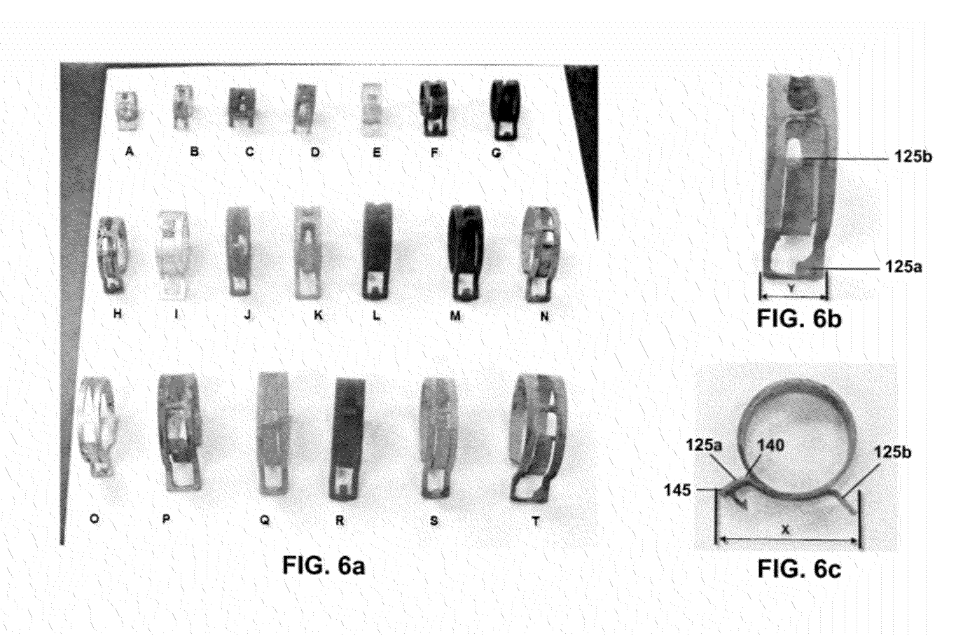

A jaw can be wider than the handle that is part of the same lever. As the size of lugs on hose clamps can vary, a wider jaw can accommodate wider lugs on hose clamps. For example, as shown in Table 1 and FIG. 6, the width of lugs on hose clamps can vary from 0.4375 inch to 0.75 inch. Referring to FIG. 8, a jaw can have a width (w). The width can be a distance measured between a first side of the jaw and a second side of the jaw. The first side of the jaw and the second side of the jaw can be parallel to a lengthwise axis of a handle (see numeral 170, FIG. 2). A jaw can be at least, 0.25 inch wide, at least 0.5 inch wide, at least 0.625 inch wide, at least 0.75 inch wide, at least 0.875 inch wide or at least 1 inch wide. However, a pliers can be used in narrow spaces. Therefore, a jaw can have a maximum width. For example, a jaw can be at most 2.0 inches wide, at most 1.75 inches wide, at most 1.5 inches wide, at most 1.25 inches wide or at most 1.0 inch wide. In preferred embodiments, a jaw can be at least 0.75 inch wide and can be at most 1.0 inch wide.

TABLE 1
Dimensions of Various Hose Clamps

| REF | X | Y |
|---|---|---|
| A | 0.75″ | 0.4375″ |
| B | 0.875″ | 0.5″ |
| C | 0.625″ | 0.625″ |
| D | 0.875″ | 0.5″ |
| E | 1.0625″ | 0.4375″ |
| F | 1.1875″ | 0.625″ |
| G | 1.5″ | 0.625″ |
| H | 1.5″ | 0.5″ |
| I | 2.0″ | 0.625″ |
| J | 1.75″ | 0.4375″ |
| K | 1.75″ | 0.625″ |
| L | 2.25″ | 0.625″ |
| M | 2.25″ | 0.625″ |
| N | 2.0″ | 0.625″ |
| O | 1.5″ | 0.5″ |
| P | 1.75″ | 0.75″ |
| Q | 2.25″ | 0.625″ |
| R | 2.5″ | 0.625″ |
| S | 2.25″ | 0.625″ |
| T | 2.1875″ | 0.75″ |

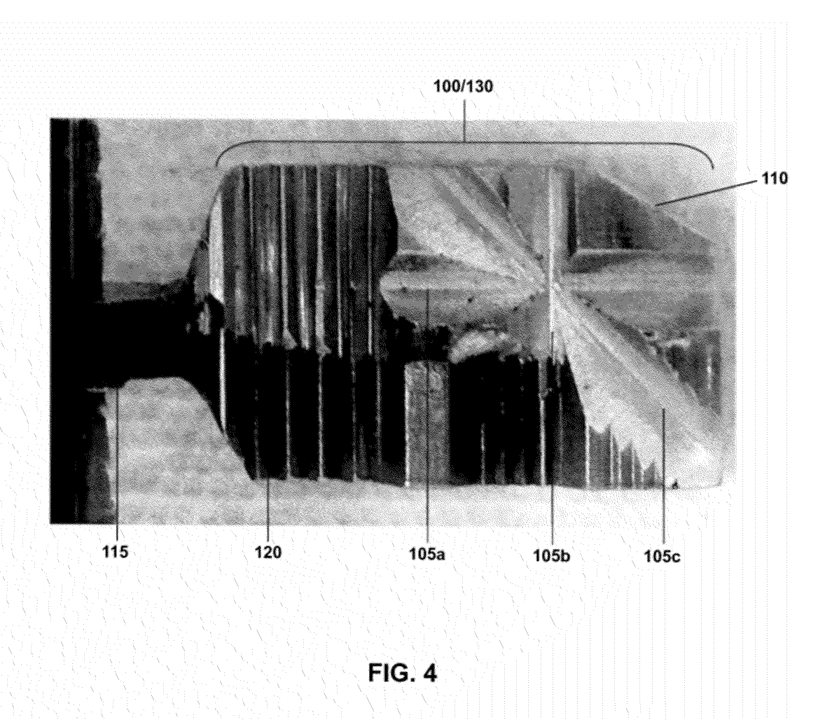

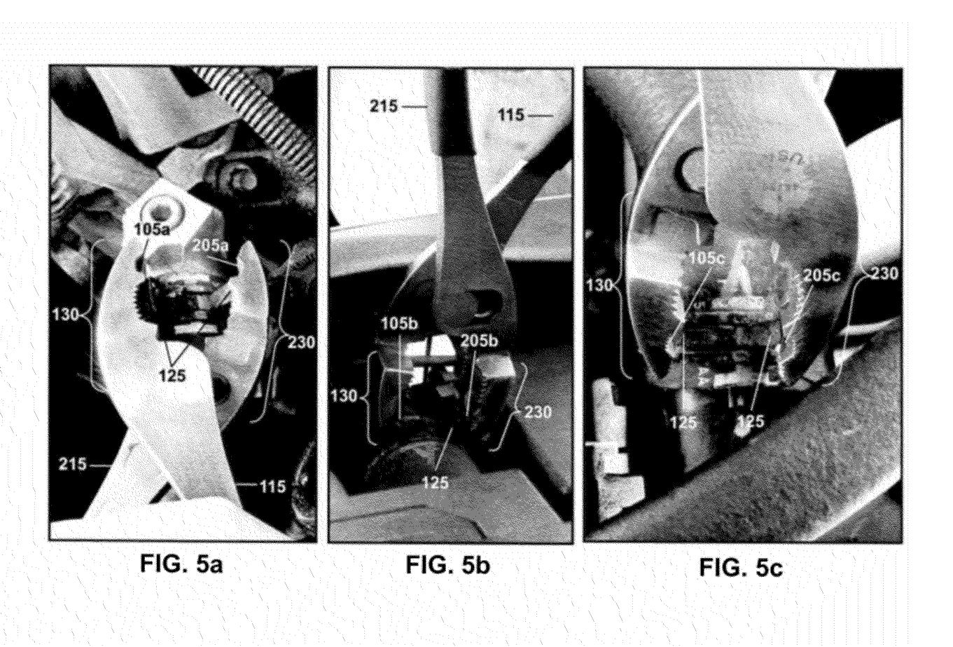

Because a jaw can be wider than the handle that is part of the same lever, the jaw can be centered along a lengthwise axis of a handle (see numeral 170, FIG. 2), for example, this configuration is shown in FIG. 4. In some embodiments, none of the side edges of a jaw can be flush with a side of the handle. Alternatively, a jaw can be off-set from a lengthwise axis of a handle (see numeral 170, FIG. 2), for example, this configuration is shown in FIGS. 1a and 1b. In other words, a jaw may be widened substantially on one side. In this configuration, one side edge of the jaw can be flush with a side of the handle (see, for example, FIG. 1a) or none of the side edges of a jaw can be flush with a side of the handle (see, for example, FIG. 1b). In some embodiments, a second handle 215 can be attached to a second jaw 230 at a position that permits the second handle 215 to pivotally rotate past the first handle 115 while maintaining alignment of a first jaw 130 and the second jaw 230, as shown in FIG. 1b.

Having a jaw off-set from a lengthwise axis of a handle can allow the jaw to accommodate a hose clamp without reducing access to areas of the engine compartment that allow limited access due to restrictions. When a jaw is off-set from a lengthwise axis of a handle, the pliers can be either left handed or right handed.

The first jaw 130 can include a first clamping surface 100, and the second jaw 230 can include a second clamping surface 200. In a pliers, a first clamping surface 100 and a second clamping surface 200 can be oriented towards each other. In this configuration, the first jaw 130 and the second jaw 230 can be brought together and an object can be clamped between the first clamping surface 100 and the second clamping surface 200.

A clamping surface can include a texture 120. A texture can be any clamping surface modification that can increase the friction between a clamping surface and an object to be clamped. For instance, a texture 120 can include small grooves (FIG. 4), cross-hatching (FIG. 3b), dimples (FIG. 3a) or bumps (FIG. 2).

The first clamping surface 100 can include a plurality of channels 105. A plurality of channels can include two, three, four or five channels. A channel can extend across the entire clamping surface (FIG. 2, channel 105c) or only a portion of a clamping surface (FIG. 2, channel 105b).

The first clamping surface 100 can include a channel 105c which is at a preselected angle relative to the first handle. The phrase “channel which is at a preselected angle” does not include channels that are at 0 degrees or 90 degrees relative to the handle. As clarification, for the purposes of determining the angle between the channel and the first handle, the channel and the handle are assumed to be part of independent imaginary lines that extend out to infinity (FIG. 2). Therefore, a channel which could be interpreted to be at 225 degrees relative to the handle will be defined as a channel which is at 45 degrees relative to the handle. As a result, a preselected angle can be defined as an angle at greater than 0 and less than 90 degrees or greater than 90 and less than 180 degrees. Exemplary preselected angles can include 45 degrees (105c) or 135 degrees (not shown) (FIG. 2).

In some embodiments, at least two channels 105 in the first clamping surface 100 may not be parallel to one another. For example, the first clamping surface 100 can include a channel 105a that is parallel to the first lever and a channel 105b that is perpendicular to the first lever. As another example, a first clamping surface 100 can include a channel 105a that is parallel to the first lever and a channel 105c that is at a preselected angle relative to the first handle.

In some circumstances, at least two channels in the first clamping surface can intersect at a point along a lengthwise axis 108 that can be at the center of the first clamping surface. In other circumstances, at least two channels in the first clamping surface can intersect at a point that is off-set from a lengthwise axis 108 that can be at the center of the first clamping surface (FIG. 1a). In still other circumstances, at least two channels in the first clamping surface do not intersect on the clamping surface.

Channels 105 are different than a texture 120 on a clamping surface 100. For example, a channel can be deeper and wider than a groove or cross-hatch added for texture. A channel can be at least 0.05 inch, at least 0.1 inch, at least 0.2 inch, at least 0.25 inch or at least 0.3 inch deep. A channel can be at least 0.05 inch, at least 0.1 inch, at least 0.15 inch, at least 0.2 inch or at least 0.25 inch wide. A channel can be twice as deep, three times as deep, or four times as deep as a groove or cross-hatch. The purpose of a channel also differs from the purpose of a groove or cross-hatch. As stated above, a groove or cross-hatch can increase the friction between a clamping surface and an object to be clamped by increasing the surface area of a clamping surface. On the other hand, a channel functions to engage a significant portion of a lug of a clamp so that pressure can be applied to the lug without the lug slipping from the clamping surface. Furthermore, multiple grooves or cross-hatches, for example more than ten grooves or cross-hatches, can be parallel to each other. Conversely, while a channel may be parallel to another channel, a channel is parallel to a small number of other channels, for example, at most five other channels. In a preferred embodiment, a channel is not parallel to any other channels.

The depth of the channel can be measured from the clamping surface, which can include a texture. Therefore, the depth of a channel can be measured from a plane including the highest points of the texture. For example, if the clamping surface includes grooves, the clamping surface will include alternating peaks and grooves. A plane can include the tips of the peaks, from which the depth of the channels can be measured.

A second clamping surface 200 can include a mirror-image plurality of channels 205 that complement corresponding channels 105 on the first clamping surface 100. For example, channel 205a can be a mirror image of and complementary channel to channel 105a, channel 205b can be a mirror image of and complementary channel to channel 105b, and channel 205c can be a mirror image of and complementary channel to channel 105c, etc. (FIGS. 1a and 1b).

In some embodiments, a first clamping surface 100 can include an angled edge 110 which is parallel to a channel (for example, 105c) in the first clamping surface 100 at a preselected angle relative to a handle 115 of the pliers. The angled edge 110 can be a fifth edge on the clamping surface 100. The angled edge of a first clamping surface can be at a preselected angle to the first handle. In other words the angled edge may not be parallel to any other edge of the clamping surface.

The lugs of a hose clamp can have a certain height. The height of a lug can be measured from the base of a lug 140 to the tip of a lug 145. The height of a lug can limit how far from an edge of a clamping surface a channel can be and still a lug engaged in the channel. The angled edge can result in the elimination a portion of the clamping surface. This can allow the pliers to engage a lug on a clamp without the additional portion of a clamping surface interfering with or preventing the pliers to get close enough to the clamp to engage a lug.

As an angled channel gets closer to a corner of a clamping surface, the length of the channel can decrease. Having an angled edge can also permit an angled channel to be close to an edge of the clamping surface while maintaining a channel length that is sufficient to engage a lug.

The second clamping surface can include an angled edge that is a mirror-image of the angled edge of the first clamping surface.

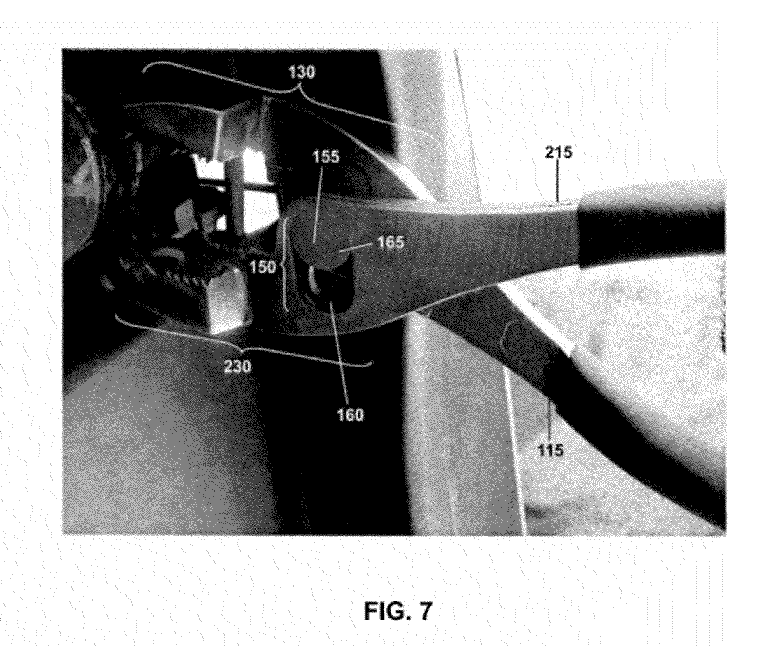

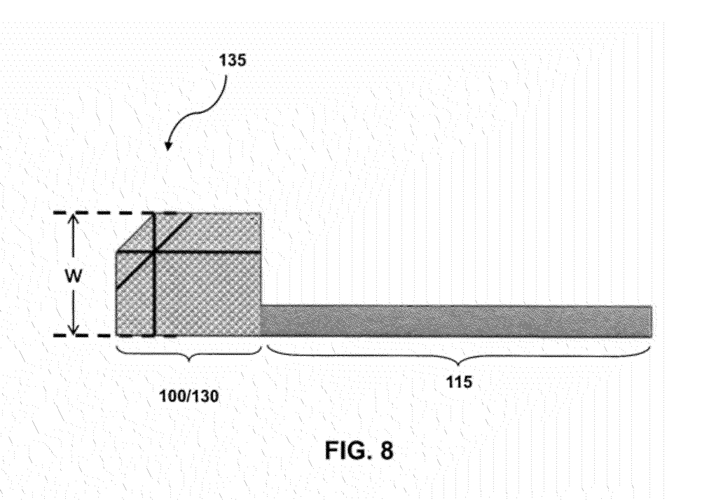

In some embodiments, a pliers can include a slip joint 150 (FIG. 7). A slip joint 150 can include a pin 155, a first position 160, a second position 165, and a track between the first position 160 and the second position 165. A slip joint can allow the pivot point of a pliers to vary. In turn, a slip joint can allow the distance the jaws can open to vary. For example, when the pin 155 is in a first position 160, the jaws 130/230 can close such that the clamping surfaces are able to touch and can open to a first width. When the pin 155 is in a second position 165, the jaws 130/230 may not be able to close, but the jaws 130/230 are able to open a wider distance than when the pin 155 was in the first position 160 (FIG. 7). This can allow a pliers which includes a slip joint to accommodate various clamps with a range of distances between the lugs x (FIGS. 6a and 6c; Table 1).

The pliers can be made from plastic, such as a high impact plastic, a metal, such as aluminum, steel or titanium, or a combination thereof.

Furthermore, the pliers can include additional features. Features may include, but are not limited to, cushioned non-slip handles or spring action handles. Additionally, a pliers can include a locking mechanism to keep the handles and jaws at a desired position, for example, in a clamped position to allow one-handed use of the pliers.

A number of embodiments of the invention have been described. Nevertheless, it will be understood that various modifications may be made without departing from the spirit and scope of the invention. Accordingly, other embodiments are within the scope of the following claims.

What is claimed is:

1. A pliers comprising:
a first lever including a first jaw and a first handle; and
a second lever including a second jaw and a second handle;
wherein the first jaw includes a first clamping surface including a plurality of channels, and at least two channels in the first clamping surface are not parallel to one another; and
wherein the second jaw includes a second clamping surface including a mirror-image plurality of channels that complement corresponding channels on the first clamping surface.

2. The pliers of claim 1, wherein the first clamping surface includes a channel that is parallel to the first lever.

3. The pliers of claim 1, wherein the first clamping surface includes a channel that is perpendicular to the first lever.

4. The pliers of claim 1, wherein the first clamping surface includes a channel that is at a preselected angle relative to the first handle.

5. The pliers of claim 4, wherein the first clamping surface includes an angled edge that is parallel to the channel in the first clamping surface at a preselected angle relative to the handle of the pliers, and the second clamping surface includes an angled edge which is a mirror-image of the angled edge of the first clamping surface.

6. The pliers of claim 1, wherein the first jaw is wider than the first handle and the second jaw is wider than the second handle.

7. The pliers of claim 1, wherein the width of the first jaw and the width of the second jaw, independently, are at least 0.5 inch wide.

8. The pliers of claim 1, wherein the width of the first jaw and the width of the second jaw, independently, are at most 1.25 inch wide.

9. The pliers of claim 1, wherein the first jaw is off-set from a lengthwise axis of the first handle, and the second jaw is off-set from a lengthwise axis of the second handle.

10. The pliers of claim 1, wherein at least two channels in the first clamping surface intersect at a point that is off-set from a lengthwise axis of the first clamping surface.

11. A method of using the pliers of claim 1 comprising:
engaging a first lug of a hose clamp in a first channel of the plurality of channels in the first clamping surface,
engaging a second lug of a hose clamp in a second channel of the plurality of channels in the second clamping surface, wherein the second channel is the complementary channel of the first channel; and
applying a force to the first handle and the second handle to release the hose clamp.

12. A method of making the pliers of claim 1 comprising:
forming the plurality of channels in the first clamping surface, wherein at least two of the channels are not parallel to one another; and
forming the mirror-image plurality of channels in the second clamping surface that complement corresponding channels on the first clamping surface.
